(19) United States
(12) Patent Application Publication
(10) Pub. No.: US 2014/0081954 A1
(43) Pub. Date: Mar. 20, 2014

(54) MEDIA INFORMATION SYSTEM AND METHOD

(71) Applicant: Kirill ELIZAROV, Hallandale Beach, FL (US)

(72) Inventor: Kirill ELIZAROV, Hallandale Beach, FL (US)

(21) Appl. No.: 14/026,276

(22) Filed: Sep. 13, 2013

Related U.S. Application Data
(63) Continuation-in-part of application No. 13/136,682, filed on Aug. 8, 2011.
Application No. 13/136,682 is a continuation-in-part of application No. 13/066,171, filed on Apr. 8, 2011, now abandoned.
(60) Provisional application No. 61/458,724, filed on Nov. 30, 2010.
(60) Provisional application No. 61/743,877, filed on Sep. 13, 2012.

(51) Int. Cl. G06F 17/30

(52) U.S. Cl. CPC G06F 17/30867
USPC 707/722; 707/770

(57) ABSTRACT

A system and method for generating thematic topics in assisting the compilation and dissemination of user generated content for citizen journalism in context from two or more media sources is provided. A first media source is queried for first topics. The first media source is one of the two or more media sources. The first topics are cross-referenced with a second media source of the one or more media sources. A most popular topic of the first topics is determined among the one or more media sources. The most popular topic has a greatest number of query and cross-reference results among the first topics. The determined most popular topic is associated with a related User Generated Content, UGC and transmitted. The resulting compendium of topics and UGC promotes development of a citizen journalism community and such online favorable reporting remains compatible with professional standards.

### CROSS-REFERENCE TO RELATED APPLICATION

This application is a continuation-in-part of patent application Ser. No. 13/136,682, filed Aug. 8, 2011, entitled MEDIA INFORMATION SYSTEM AND METHOD, which is a continuation-in-part of patent application Ser. No. 13/066,171, filed Apr. 8, 2011, entitled MEDIA INFORMATION SYSTEM AND METHOD, which claims priority to Provisional Application Ser. No. 61/458,724, filed Nov. 30, 2010, entitled MEDIA INFORMATION SYSTEM & METHOD, the entirety of all of which are incorporated herein by reference. This application is related to and claims priority to U.S. Provisional Patent Application Ser. No.: 61/743,877, filed Sep. 13, 2012, entitled MEDIA INFORMATION SYSTEM AND METHOD, the entirety of which is incorporated herein by reference.

### STATEMENT REGARDING FEDERALLY SPONSORED RESEARCH OR DEVELOPMENT

n/a

### FIELD OF THE INVENTION

The present invention relates to a method and system for media information systems and methods.

### BACKGROUND OF THE INVENTION

Television and mass media are an integral part of human life, and television and web media are a major source of information relating to news, politics, sports and entertainment available to public consumers. Typical television and web media present information in a serial process where a television program or web site interface presents a series of images, text or video segments that are broadcast to viewers without real-time feedback or participation from the viewers. The viewers have limited or no opportunity to participate with the broadcast content of the television program or web site interface.

Initially, the evolution to a more interactive form of television programming or web site content, where the viewer is allowed to participate, is limited due to the lack of bidirectional communication channels between the viewer and television program broadcaster or web site host. As bidirectional communication channels have been developed, the communication channels did not have sufficient bandwidth to communicate complex viewer interactions with the broadcast television programming or web site. As service provider bandwidth has improved, interactive television and web programming has become more prevalent. Viewer participation has, however, remained limited to selecting television content, responding to advertising message, and responding to questionnaires or polls because interactive television and web programming continue to follow a conventional broadcast paradigm where the television programming is wrapped in advertisements and the audience continues to watch linearly pre-recorded programming.

No service offering fully includes the audience or participants in a rich participatory experience where the audience has influence over the programming as an originator of an interactive television program or web site program. Instead, the television programming and web sites are controlled by the broadcasters and hosts and all information provided to the viewers/visitors is controlled or scrutinized by the broadcaster or hosts that produce the programming content. The comments or communication with respect to the viewer's/visitor's particular views on the subject matter of the television programming or web broadcast is not available to be shared or discussed and commented on a real-time basis during the television or web broadcast itself.

### SUMMARY OF THE INVENTION

The present invention advantageously provides a method and system for providing media information from a plurality of media sources. A method includes querying a first media source for first topics. The first media source is one of the two or more media sources. The first topics are cross-referenced with a second media source of the one or more media sources. A most popular topic of the first topics is determined among the one or more media sources. The most popular topic has a greatest number of query and cross-reference results among the first topics. The determined most popular topic is associated with a related User Generated Content, UGC. The associated most popular topic and UGC is transmitted.

In accordance with an aspect of this embodiment, the greatest number of query and cross-reference results is calculated as one of a greatest number of search queries, visits, comments, posts and re-posts and links. In accordance with another aspect of this embodiment, a semantic filter is applied to the determine most popular topic to determine a category of the determined popular topic. The UGC is related to the determined category. In accordance with yet another aspect of this embodiment, the combined determined topic and related UGC is transmitted to a moderator module. A discussion vector of the moderated media stream is determined, and the related UGC is adjusted based on the discussion vector. In accordance with still another aspect of this embodiment, adjusting the related UGC includes one of promoting a first UGC in a queue and demoting a second UGC in the queue based on the determined discussion vector. The queue is associated with the determined topic.

In accordance with a further aspect of this embodiment, a subject matter of each of the first topics is determined. The first topics having a same subject matter are combined. In accordance with another aspect of this embodiment, cross-referencing the first topics with the second source includes selecting one of the first topics. The selected first topic is queried in the second media source. A search result of the selected first topic from the second media source is combined with a search result of the selected first topic in the first media source. A combined search result for each of the first topics is computed and sorted. In accordance with yet another aspect of this embodiment, cross-referencing the first topics with the second source further includes combining the first topics having a same subject matter. A collective result for the combined first topics is computed.

A media information system is in communication with two or more media sources to provide a media presentation. The media information system includes an analyzer configured to provide a most popular topic selected from the two or more media sources by querying a first media source for first topics. The first media source is one of the two or more media sources. The first topics are cross-referenced with a second media source of the two or more media sources. A most popular topic of the first topics is determined among the plurality of media sources. The most popular topic has a greatest number of query and the cross-reference results. The media information server further includes a media server in communication with the analyzer. The media server associates the determined most popular topic with a related User Generated Content, UGC, and transmits the associated most popular topic and UGC.

In accordance with an aspect of this embodiment, a database is in communication with the analyzer and the media server. The database is configured to store two or more UGC that are referenced in a queue and related to the determined most popular topic. In accordance with another aspect of this embodiment, the greatest number of query and cross-reference results is calculated as one of a greatest number of search queries, visits, comments, posts and re-posts and links. In accordance with yet another aspect of this embodiment, the analyzer is further configured to apply a semantic filter to the determined most popular topic to determine a category of the most popular topic. The UGC is related to the determined category. In accordance with still another aspect of this embodiment, the media server is further configured to transmit the combined determined topic and related UGC to a moderator module. A discussion vector of the broadcast media stream is determined and the related UGC is adjusted based on the determined discussion vector.

In accordance with a further aspect of this embodiment, the media server is configured to adjust the related UGC by one of promoting a first UGC in a queue and demoting a second UGC in the queue based on the determined discussion vector. In accordance with another aspect of this embodiment, the analyzer is further configured to determine a subject matter of each of the first topics. The first topics having a same subject matter are combined. In accordance with yet another aspect of this embodiment, the analyzer is configured to cross-reference the first topics with a second media source by selecting one of the first topics. The second media source is queried for the selected first topic. A search result of the selected first topic from the second media source is combined with a search result of the selected first topic from the first media source. A combined search result for each of the first topics is computed and sorted. In accordance with still another aspect of this embodiment, the analyzer is further configured to combine the first topics having a same subject matter. A collective result for the combined first topics is computed.

A method of transmitting media from aggregating search results for first topics queried from a first media source with all media sources of two or more media sources includes querying the first media source for the first topics and selecting one of the first topics. The selected first topic is queried for in a second media source. The second media source is one of the two or more media sources. A search result of the selected first topic from the second media source is combined with a search result of the selected first topic from the first media source. A combined search result for each of the first topics is computed and sorted to determine a most popular topic of an aggregate of the two or more media sources. The determined most popular topic is associated with User Generated Content, UGC, that is related to the determined most popular topic. The combined determined most popular topic and related UGC are transmitted.

In accordance with an aspect of this embodiment, a subject matter of each of the first topics is determined. The first topics having a same subject matter are combined. A combined search result for the combined first topics is computed. A semantic filtered configured to determine a category of the determined most popular topic is applied to the determined most popular topic. The associated determined most popular topic and related UGC are transmitted to a moderator module. A discussion vector of the broadcast media stream is determined. The related UGC is adjusted based on the determined discussion vector.

In accordance with another aspect of this embodiment, adjusting the related UGC includes one of promoting a first UGC in a queue and demoting a second UGC in the queue based on the determined discussion vector. The queue is associated with combined determined topic.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a system diagram of a media information system constructed according to an exemplary embodiment of the present invention;

FIG. 2 is a block diagram representation of a web server of the media information system according to another exemplary embodiment of the present invention;

FIGS. 3 and 4 are a process flow diagram of a media information method according to an exemplary embodiment of the present invention; and

FIG. 5 is a process flow diagram of cross-referencing topics and media sources according to an exemplary embodiment of the present invention;

FIG. 6 is a screenshot of a user interface according to an exemplary embodiment of the present invention;

FIG. 7 is a search result table according to an exemplary embodiment of the present invention; and

FIG. 8 is a cross-reference table according to an exemplary embodiment of the present invention.

### DETAILED DESCRIPTION OF THE INVENTION

Embodiments of the present invention provide an interactive media platform that combines social networking and broadcasting into a single multimedia experience. The interactive media platform allows users in a broadcast audience to participate in the broadcast programming by including users' comments and feedback in the broadcast. This allows the user to fully participate in a discussion forum with a news broadcast and exposes an audience and the news outlets to a wider range of viewpoints. Using a queue of users and user generated content, the interactive platform allows a limitless number of users to participate in a discussion forum in the broadcast programming where content of interest is continually added as the broadcast programming develops or evolves or as popular or trending topics develop.

As used herein, relational terms, such as “first” and “second,” “top” and “bottom,” and the like, may be used solely to distinguish one entity or element from another entity or element without necessarily requiring or implying any physical or logical relationship or order between such entities or elements.

In embodiments described herein, the joining term, “in communication with” and “connected to,” and the like, may be used to indicate electrical or data communication, which may be accomplished by physical contact, induction, electromagnetic radiation, radio signaling, infrared signaling or optical signaling, for example. The above methods of achieving electrical or data communication are non-limiting and mentioned only for illustration. One having ordinary skill in the art will appreciate that multiple components may interoperate and modifications and variations are possible of achieving the electrical and data communication.

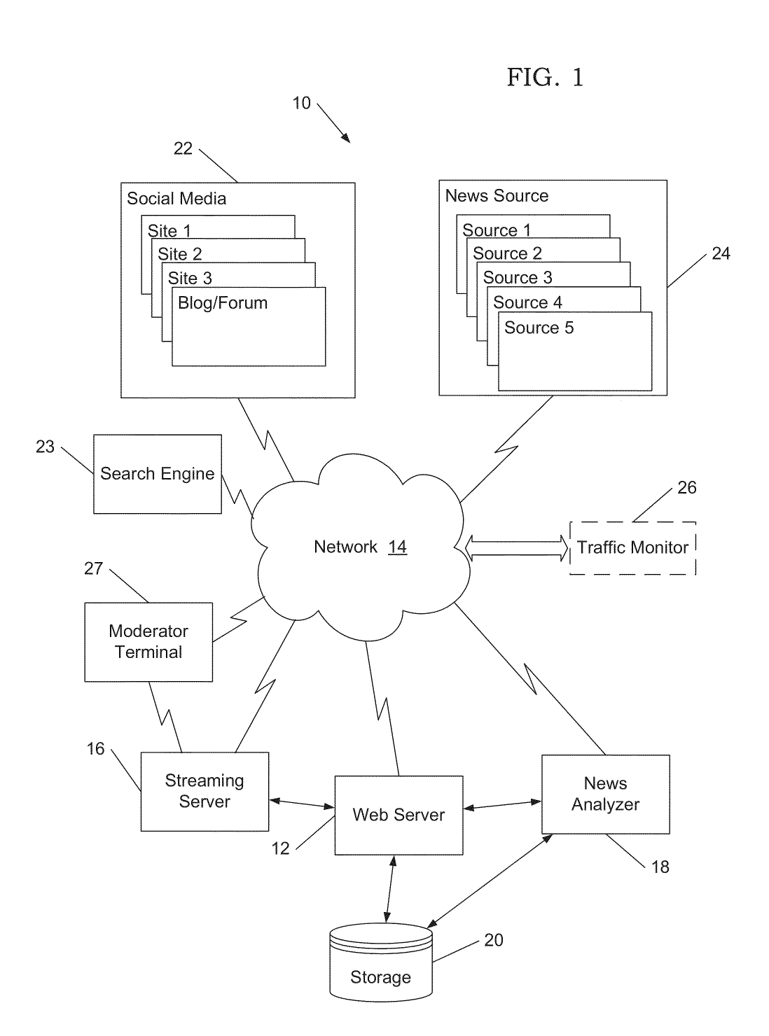

Referring to the drawing figures in which like reference designators refer to like elements, FIG. 1 shows a system diagram of a media information system 10 according to an exemplary embodiment of the present invention. The media information system 10 includes a web server 12 in communication with a network 14. A streaming server 16, a news analyzer 18 and a storage 20 are in communication with the web server 12. The streaming server 16 and the news analyzer 18 are in communication with the network 14. According to some exemplary embodiments, the streaming server 16, the news analyzer 18 and the web server 12 may represent specially implemented functionality executable on general purpose computers. It will be appreciated that a general purpose computer may include, for example, a processor, memory arranged to store instructions executable by the processor, a communication interface for communicating with the network 14. It will be further appreciated that a general purpose may be specially configured to execute the functionality of the streaming server 16, the news analyzer 18 and the web server 12. The web server 12 provides web content and may host a web site or application server, for example. The network 14 may include, for example, a packet-switched network, a circuit-switched network or a combination thereof. The network 14 may be, for example, a local area network, LAN, wide area network, WAN and the Internet. The storage 20 includes, for example, removable and/or non-removable transitory and/or non-transitory memory and may be a database.

A social media source 22 is in communication with the network 14. The social media source 22 is a service or application where individuals may interact to create, share and exchange information and ideas and may include, for example, Reddit™, Twitter™, Facebook™ Youtube™, blogs (web logs) and discussion forums. A search engine 23 is in communication with the network 14. The search engine 23 is a part of a data-gathering software system that is configured to search for information on the World Wide Web and present results in a results page. The search engine 23 may track statistics regarding the search queries, shares, comments or likes relating to news content or UGC, and may include, for example, the query topic or theme, the location of the query user/requestor, the rate of received queries and previous queries from the user. The search engine 23 maintains real-time information on the content available on the web by running an algorithm on or as part of a web crawler. The search engine 23 may include, for example, Yahoo!™, Google™ and Bing™ or any other system or service that allows retrieval, from the World Wide Web, of the most searched for, shared, commented or “liked” news content or topic or any other use-generated or use-based content or statistic. A news source 24 is in communication with the network 14. The news source 24 is a mass media service that focuses on delivering news. The news source 24 delivers news by print media (newspapers and magazines), broadcast news (audio and visual) and the Internet. The news source 24 may include, for example, the Associated Press™, CNN™, the Huffington Post™, Yahoo! News™ and MSN™. The social media source 22, the search engine 23 and the news source 24 may be accessed by the user via a web-based user interface, an application interface, or an Application Programming Interface (API). The social media source 22, the search engine 23, the news source 24 and the traffic monitor 26 are interchangeably referred to hereinafter as a media source or media sources.

The social media source 22, the search engine 23 and the news source 24 are accessible by the streaming server 16, the web server 12 and the news analyzer 18. According to some exemplary embodiments, the media information system 10 includes a traffic monitor 26 that is in communication with the network 14. The traffic monitor 26 is a tracking service that monitors and tracks request and response traffic for the social media source 22, the search engine 23 and the news source 24. The web server 12, the streaming server 16 and the news analyzer 18 are in communication with a moderator terminal 27 over the network 14.

The news analyzer 18 is in communication with the media sources and may query the media sources to perform analytics. According to an exemplary embodiment, the news analyzer 18 is arranged to query the media sources to determine a popular or trending topic, which may be determined, for example, as a topic having a greatest number of search queries during a predetermined time period or a topic having a highest and/or increasing rate of queries at a particular instance in time. It will be appreciated that “search queries” as used hereinabove and through this application refers to search queries, shares, comments, votes/likes, posts/re-posts, links or any other type of social media interaction and any combination of the above. According to another exemplary embodiment, the news analyzer 18 is arranged to parse user submissions including, for example, user comments/feedback for an article, user status posts on Facebook™ or submissions using a short message service on Twitter™. According to yet another exemplary embodiment, the news analyzer 18 is further arranged to determine how many visits or requests a web page undergoes or how many times the web page is linked to from another third party site or service. The news analyzer 18 may apply semantic filters to analytic data from the media sources to determine common themes and consolidate the analytic data to thematic topics. In this way, the news analyzer 18 may determine popular or trending topics based on analysis of the media sources, which includes not only the content being pushed to users in publications and content from the news source 24, but also user activity on social media 22 and user activity on search engine 23. The news analyzer 18 may also obtain user generated content (UGC) that may be published on social media 22 that may be related to the popular or trending topics. The UGC includes text, audio and video data created by a user that may be relevant to the respective popular or trending topic.

The streaming server 16 is a multimedia server that receives topics that are determined to be popular or trending from the news analyzer 18 and combines or associates the popular or trending topics with the UGC that is related to the popular or trending topic. The news analyzer 18 and/or the streaming server 16 maintain the UGC in a queue. The queue includes pointers to content that is stored in storage 20, in the case of pre-recorded content. In the case of real-time UGC, the queue includes a pointer to the user's location or content feed. The streaming server 16 also provides moderation of the combined content whereby queued UGC is promoted and demoted based on the UGC's relevance to the associated popular or trending topic. The streaming server 16 selects and highlights UGC having particular relevance, on a user interface. The streaming server 16 broadcasts or transmits the popular or trending topics and the UGC to the user interface on the network 14. According to some other exemplary embodiments, the streaming server 16 transmits content to the user interface through a host such as the web server 12. The moderator terminal 27 is configured to communicate with the streaming server 16 to control the bidirectional traffic of UGC, media and the incoming and outgoing participation of users and UGC in the queue.

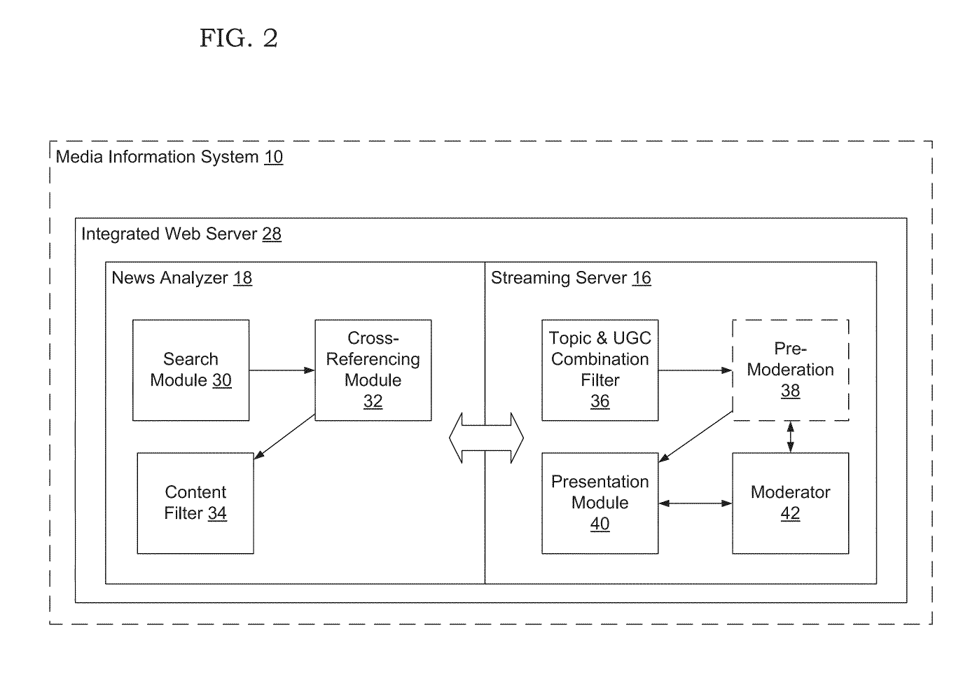

An integrated web server 28 according to another exemplary embodiment of the present invention is described with reference to FIG. 2. Similar to the web server 12 discussed above, the integrated web server 28 may be included in the media information system 10 and in communication with the network 14. The integrated web server 28 may be configured to include the news analyzer 18 and the streaming server 16 integrated therein. In other words, the streaming server 16 and the news analyzer 18 may be integrated with the web server 12 as a single device in the integrated web server 28. For the sake of simplicity and clarity only the streaming server 16 and news analyzer 18 are shown in the integrated web server 28. The news analyzer 18 includes a search module 30, a cross-referencing module 32 and a content filter 34. The streaming server 16 includes a topic & User Generated Content (UGC) combination filter 36, a pre-moderation module 38, a presentation module 40 and a moderation module 42.

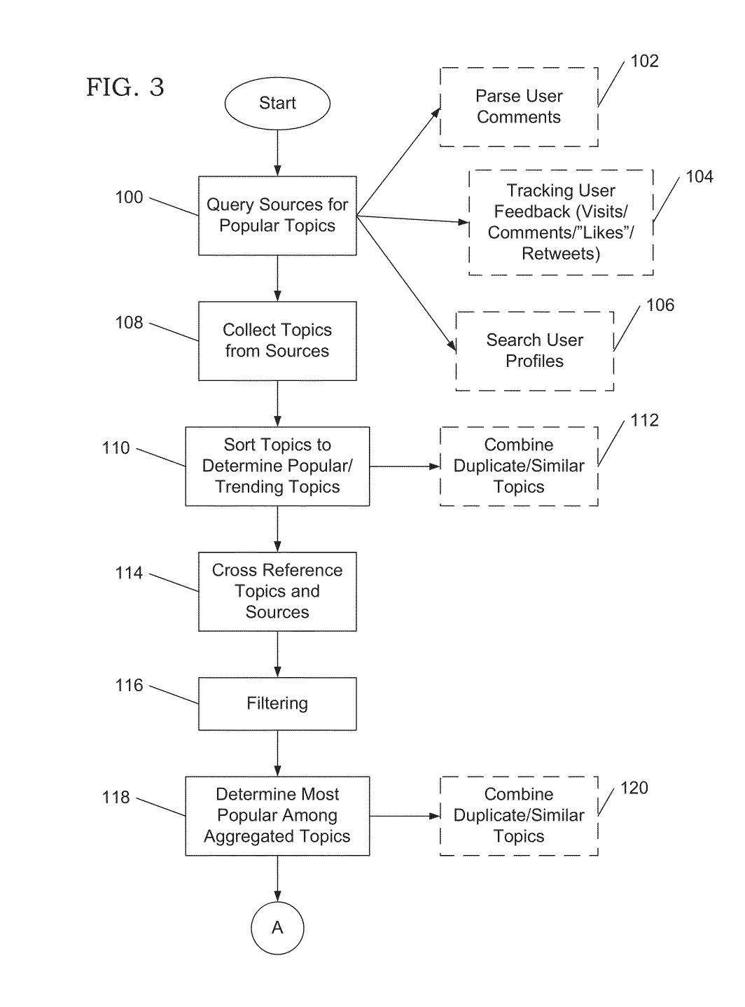

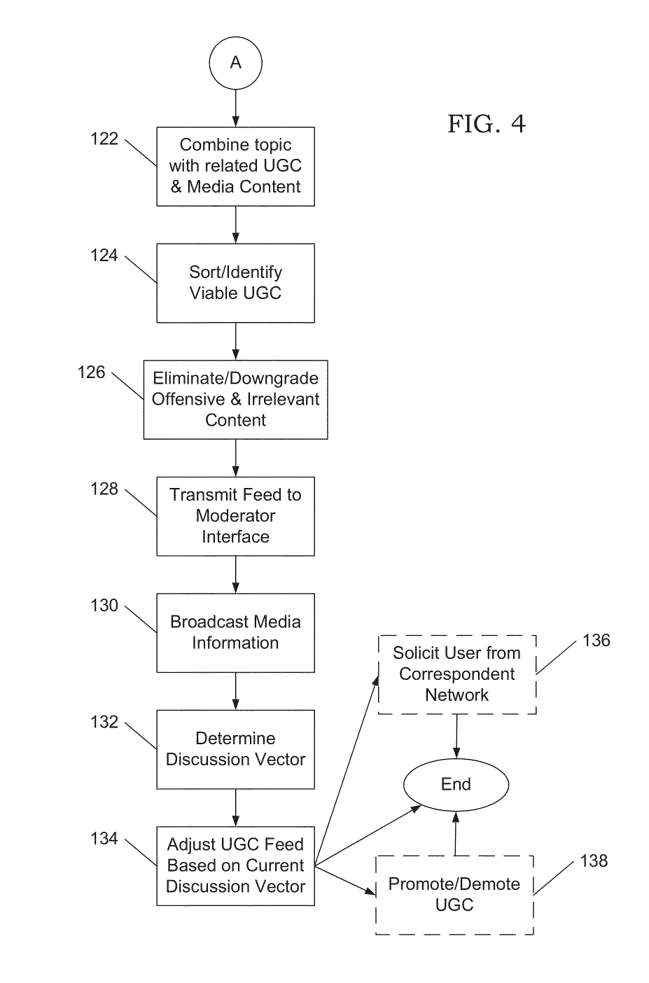

A process of providing an interactive media platform is described with reference to FIGS. 3 and 4. The search module 30 of the news analyzer 18 queries a media source, which may include the social media source 22, the search engine 23 and the news source 24 for one or more topics (block 100). The search module 30 may be configured to periodically query the media sources or in response to a user command, e.g., a moderator or producer command. Querying the source may include, for example, automatically parsing user comments of a message board or comment section of an article (block 102), tracking user feedback of an article or thread (block 104) or searching user profiles for topics (block 106). It will be appreciated that user feedback may include, for example, a number of visits a user or users visit a webpage (repeat visit or unique visit), a number of comments or a content of comments left for a message board topic, a number of “Likes,” a number of Upvotes, or a number of re-Tweets relating to a topic. It will be appreciated that the news analyzer 18 may be configured to utilize an API (not pictured) to interface with the social media source 22, the search engine 23, the news source 24 and the traffic monitor 26. The news analyzer 18 is configured to collect the one or more topics (block 108) and sort the topics (block 110) to determine the one or more most popular or trending topics of the source. According to some exemplary embodiments, it may be necessary to remove duplicate topics or consolidate topics that are similar (block 112).

The cross-referencing module 32 of the news analyzer 18 is configured to cross-reference the topics with another source (block 114) to obtain a more accurate determination of popular or trending topics across multiple sources. The content filter 34 of the news analyzer streaming server 16 is configured to perform semantic filtering of the topics (block 116) to clarify the topics and remove noise as well as to determine a category of the topics. The news analyzer 18 is further configured to determine the most popular topics among the sources (block 118). Due to a possible non-uniformity of topics or the depiction of topics among different media sources, it may be necessary to remove duplicate topics or consolidate topics that are similar (block 120), which is accomplished by using topical keywords determine duplicate topics.

The topic and UGC combination filter 36 of the streaming server 16 is configured to combine UGC that is relevant to the category of the determined popular topic (block 122). In particular, the UGC may include text, audio and video data relating to the respective topic, which may itself have media content from one of the sources. The topic and UGC combination filter 36 may add the UGC to a queue. The pre-moderation module 38 of the streaming server 16 is configured to sort and identify, among the submitted UGC, UGC that is appropriate and relevant to the UGC and may include an indication, for a moderator, that the identified UGC is appropriate for broadcast or discussion (block 124). According to some exemplary embodiments, the pre-moderation module 38 may be configured to flag a queued UGC that is of particular relevancy or importance. According to some exemplary embodiments, the pre-moderation module 38 may be configured to highlight or set aside UGC from a verified source, witness or a subject matter expert, for example. The pre-moderation module 38 of the streaming server 16 is configured to eliminate or downgrade UGC content (block 126) from the submitted UGC that may be offensive (include profanity or offensive language or inappropriate gestures) or irrelevant to the topic.

The presentation module 40 of the streaming server 16 is configured to transmit the topic(s) determined to be popular and the remaining UGC to a moderator module 42 (block 128). The moderator module 42 is configured to implement an interface that is controlled by the moderator and governs the final media information that is broadcast (block 130) by the streaming server 16. One having ordinary skill will appreciate that the final media information may be broadcast, streamed or published as text, audio or video. It will also be appreciated that the moderator may be, for example, a host of a media information program or a producer of the media information program. During the broadcast of the media information, the news analyzer 18 determines a discussion vector of the media information program (block 132). In other words, the news analyzer 18 is configured to determine whether the topic of the media information program is trending or shifting from the determined popular topic to a different topic, a subtopic or a corollary topic (block 132). It will be appreciated that the news analyzer 18 may rely on feedback found in the content of the broadcast media information itself or the media sources to determine the trend or shift of the popular topic. If the topic trends of shifts, it may be necessary to adjust the UGC and the broadcast media so that the broadcast media information continues to trend and remain relevant. Thus, the topic and UGC combination filter 36 of the streaming server 16 is configured to determine whether the UGC that is queued for inclusion in the media information program should be altered (block 134) and identifies relevant UGC for inclusion or eliminates irrelevant UGC from the queued UGC (block 138).

According to some exemplary embodiments, the topic and UGC combination filter 36 may be configured to solicit user generated content from particular users of, for example, a correspondent network or panel (block 136).

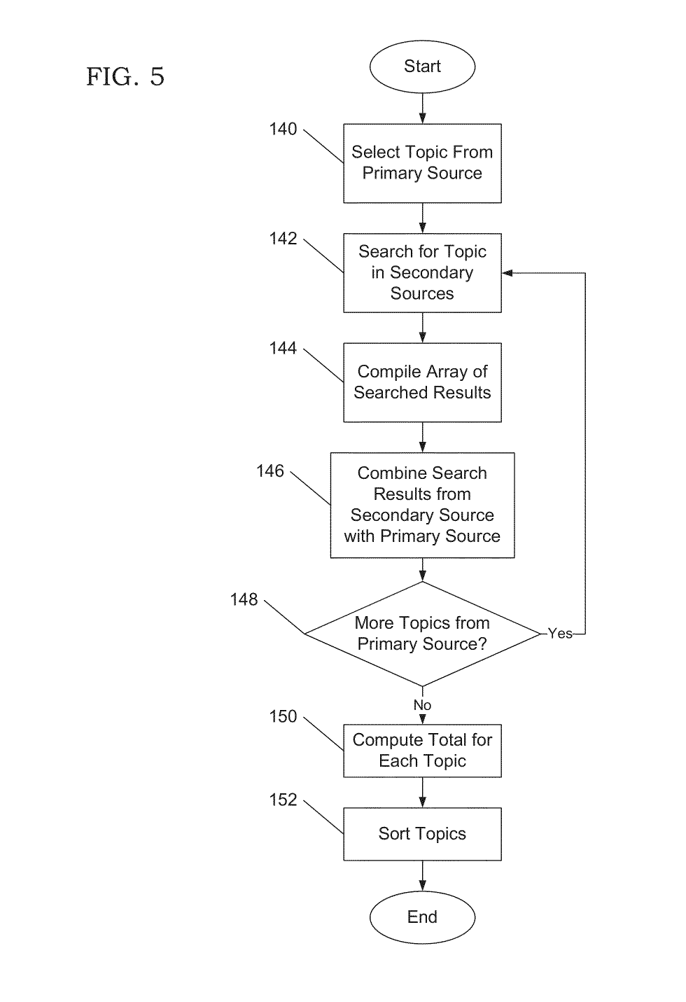

FIG. 5 shows a process flow diagram of cross-referencing topics with media sources according to an aspect of the exemplary embodiment of the present invention. It may be desirous to cross-reference topics determined from a first media source as being popular or trending across one or more second media sources to obtain topics that are less biased and dependent on the relevant media source (i.e., a first media source) relied on for the one or more topics. Thus, the cross-referencing module 32 of the news analyzer 18 selects a first topic from the first media source (block 140). The cross-referencing module 32 searches for the selected first topic in a second media source that is different than the first media source (block 142). The cross-referencing module 32 may search for the selected first topic in all available second media sources that are different than the first media source to produce an array of search results (block 144). The cross-referencing module 32 combines the search result from the first media source with the array of search results from the second media sources (block 146). Each topic is cross-referenced (block 148) to produce a complete search calculation across all available media sources for all popular topics. The cross-referencing module 32 computes a total for each in the array of search results (block 150) and sorts the topics based on array of search results (block 152).

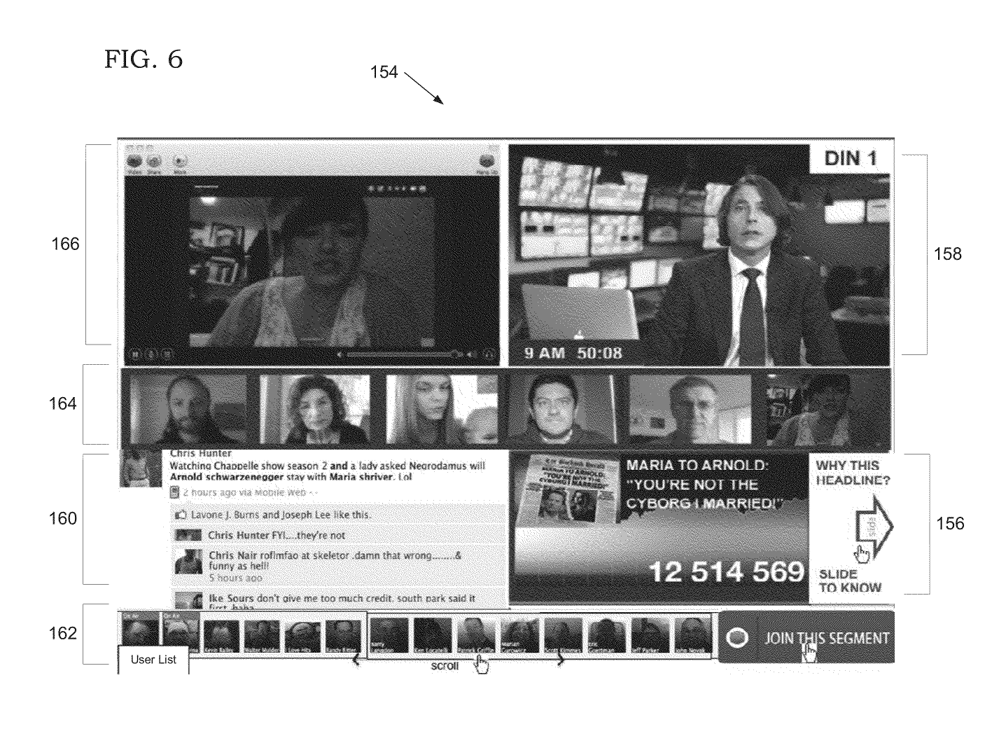

A view of an exemplary user interface 154 is described with reference to FIG. 6. The user interface 154 displays content that is broadcasted by the streaming server 16. The user interface 154 is an application running on a user's device or accessible by the user's device. According to some exemplary embodiments, the user interface 154 may be a remote application accessible by the user's device. The user interface 154 shows a discussion forum that includes a number of panels relating to a headline panel 156. The headline panel 156 displays a headline that relates to the most popular or trending topic being discussed in the discussion forum of the user interface 154. A host panel 158 displays video and audio of a host who controls the discussion forum. According to some exemplary embodiments, the host operates the moderator terminal 27 to coordinate the content shown on the user interface 154. Queued UGC that is associated with the popular or trending topic is shown in a continuously scrolling feed 160. The scrolling feed 160 shows stored UGC that is pre-recorded or extracted from media sources such as Facebook™ Google+™, Twitter™, MySpace™, Pinterest™ and other social media status posts and replies and Youtube™ videos, for example.

A waiting list 162 shows users that have joined the discussion forum and who are waiting for an opportunity to participate in a discussion panel 164. The discussion panel 164 shows images and/or video of real-time UGC. In other words, the discussion panel 164 shows, in real-time, video or audio commentary of a user. In this way, users interact in real-time with the host as well as other users who are participating in the discussion forum. Users in the discussion panel 164 may automatically roll-off after a time period expires. According to some exemplary embodiments, the users are automatically removed from the discussion panel 164 by the moderator terminal 27 after the users submit a comments or statement. According to other exemplary embodiments, the users are selectively removed from the discussion panel 164 by the host. When a user rolls-off or is removed from the discussion panel 164, a user in the waiting list 162 is automatically added to the discussion panel 164.

A focus panel 166 shows highlighted UGC selected from the discussion panel 164 or the scrolling feed 160. The highlighted UGC may be content that is selectively promoted by the host. It will be appreciated that the moderator terminal 27 and/or the host selectively promotes or demotes users in the waiting list 162. The moderator terminal 27 and/or the host also selectively promotes or demotes content from the scrolling feed 160 and the discussion panel 164 to the focus panel 166 as appropriate, e.g., to initiate or further discussion.

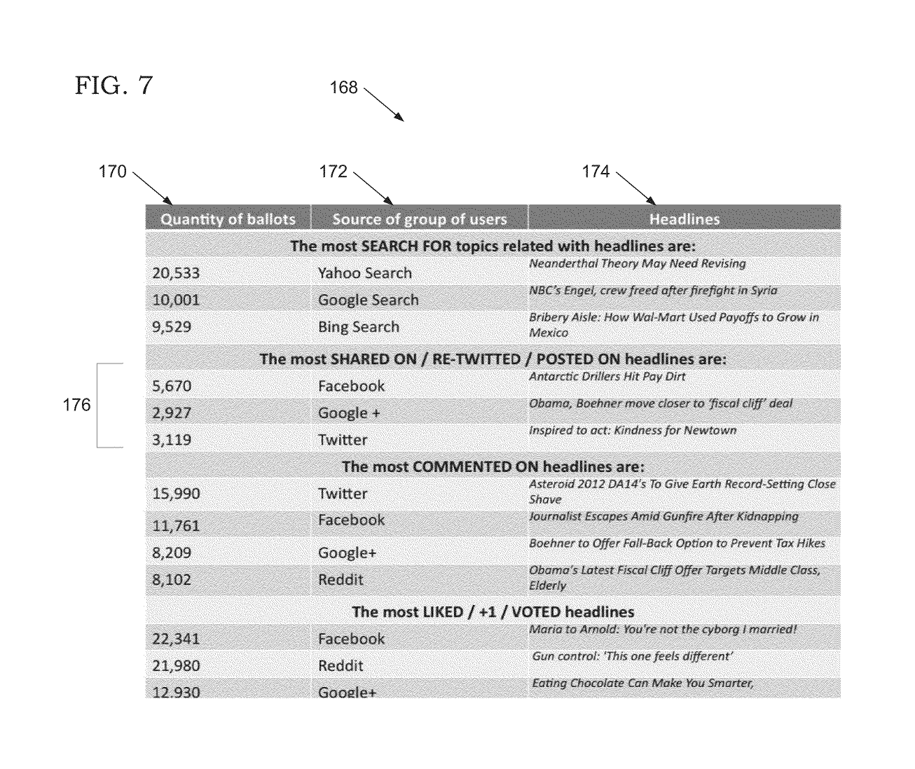

A view of a search result table 168 according to an exemplary embodiment is described with reference to FIG. 7. The search result table 168 shows a result of a number of queries executed on a number of media sources for each media source's most popular topics. Each media source produces a line item in the search result table 168 and includes a number of ballots 170, a source 172 and a headline 174. The number of ballots 170 represents a quantity that represents a number of search queries, shares, comments, votes/likes, posts/re-posts, links or any other type of social media interaction relating to the headline 174 as reported by the source 172. The results may be organized into a group 176 based on the nature of the source 172, for example.

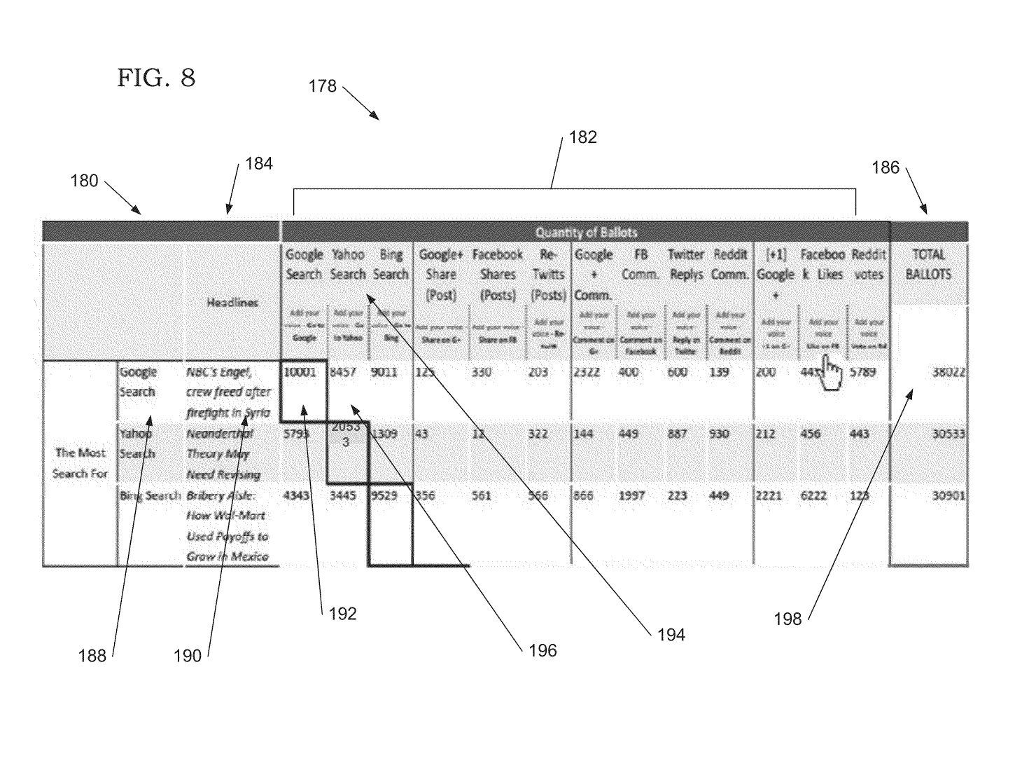

A view of a cross-reference table 178 according to an exemplary embodiment is described with reference to FIG. 8. The cross reference table 178 shows an array of query results executed on a number of media sources. Each row 180 and column 182 refers to one of the media sources. Based on the popular topics, which were determined in the search result table 168, for example, a query of each determined popular topic 184 is executed in each media source, and a total ballot result 186 for all of the media sources is calculated for each popular topic 184. The total ballot result 186 for all the media sources may then be sorted to determine a most popular topic of the aggregate among all the media sources. For the sake of clarity and simplicity, the cross-reference table 178 shows only a portion of a full cross-reference table. It will be appreciated that the full cross-reference table may be an N×N array, where N equals a number of media sources.

By way of illustrative example, the first row of the cross-reference table 178 shows that a query of Google™ 188 produced a most popular topic 190 based on the number of ballots 192. In the illustrative example, the Google™ search produced 10,001 ballots. A query of the most popular topic 190 from Google™ is then executed in the other media sources. For example, a query of the most popular topic 190 is executed in Yahoo™ 194, which produces a number of ballots 196. In the illustrative example, the Yahoo™ search produced 8,457 ballots. This query is performed for all the media sources and a total ballot result 198 for the most popular topic 190 is calculated as a sum of the number of ballots for each media source across the columns 182. In the illustrative example, the most popular topic 190 produced a total of 38,022 ballots across all the media sources.

Thus, the present invention allows users in a broadcast audience to interact, in real-time with broadcast programming. This is a shift from conventional broadcasting paradigms where only pre-selected guests participate in forums to discuss pre-selected subject matter. Instead, the present invention allows users to fully participate with the broadcast programming by adding UGC as well as to collectively select the broadcast content.

The present invention can be realized in hardware, or a combination of hardware and software. Any kind of computing system, or other apparatus adapted for carrying out the methods described herein, is suited to perform the functions described herein. A typical combination of hardware and software could be a specialized computer system, having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A method for providing media information from a plurality of media sources, the method comprising:
querying a first media source for first topics, the first media source being one of the plurality of media sources;
cross-referencing the first topics with a second media source of the plurality of media sources;
determining, among the plurality of media sources, a most popular topic of the first topics, the most popular topic having a greatest number of query and cross-reference results among the first topics;
associating the determined most popular topic with a related User Generated Content, UGC; and
transmitting the associated most popular topic and the UGC.

2. The method according to claim 1, wherein the greatest number of query and cross-reference results is calculated as one of a greatest number of search queries, visits, comments, posts and re-posts, shares, votes and links.

3. The method according to claim 1, further comprising:
applying a semantic filter to the determined most popular topic, the semantic filter configured to determine a category of the determined most popular topic, wherein the UGC is related to the determined category.

4. The method according to claim 3, further comprising:
transmitting the combined determined topic and related UGC to a moderator module;
determining a discussion vector of the moderated media stream; and
adjusting the related UGC based on the determined discussion vector.

5. The method according to claim 4, wherein adjusting the related UGC comprises:
one of promoting a first UGC in a queue and demoting a second UGC in the queue based on the determined discussion vector, the queue being associated with the determined most popular topic.

6. The method according to claim 1, further comprising:
determining a subject matter of each of the first topics; and
combining the first topics having a same subject matter.

7. The method according to claim 1, wherein cross-referencing the first topics with the second source comprises:
selecting one of the first topics;
querying the second media source for the selected first topic;
combining a search result of the selected first topic from the second media source with a search result of the selected first topic from the first media source;
computing a combined search result for each of the first topics; and
sorting the computed combined search results.

8. The method according to claim 7, wherein cross-referencing the first topics with the second source further comprises:
combining the first topics having a same subject matter; and
computing a collective result for the combined first topics.

9. A media information system in communication with a plurality of media sources to provide a media presentation, the media information system comprising:
an analyzer configured to provide a most popular topic selected from the plurality of social media sources by:
querying a first media source for first topics, the first media source being one of the plurality of media sources;
cross-referencing the first topics with a second media source of the plurality of media sources; and
determining, among the plurality of media sources, the most popular topic of the first topics, the most popular topic having a greatest number of query and cross-reference results; and
a media server in communication with the analyzer, the media server configured to:
associate the determined most popular topic with User Generated Content, UGC; and
transmit the associated most popular topic and UGC.

10. The media information system of claim 9, further comprising:
a database in communication with the analyzer and the media server, the database configured to store a plurality of UGC relating to the determined most popular topic, the plurality of UGC being referenced by a queue.

11. The media information system of claim 9, wherein the greatest number of query and cross-reference results is calculated as one of a greatest number of search queries, visits, comments, posts and re-posts, shares, votes and links.

12. The media information system of claim 9, wherein the analyzer is further configured to:
apply a semantic filter to the determined most popular topic, the semantic filter configured to determine a category of the most popular topic, wherein the UGC is related to the determined category.

13. The media information system of claim 12, wherein the media server is further configured to:
transmit the combined determined topic and related UGC to a moderator module;
determine a discussion vector of the broadcast media stream; and
adjust the related UGC based on the determined discussion vector.

14. The media information system of claim 13, wherein the media server is configured to adjust the related UGC by:
one of promoting a first UGC in a queue and demoting a second UGC in the queue based on the determined discussion vector.

15. The media information system of claim 9, wherein the news analyzer is further configured to:
determine a subject matter of each of the first topics; and
combine the first topics having a same subject matter.

16. The media information system of claim 9, wherein the analyzer is configured to cross-reference the first topics with a second media source by:
selecting one of the first topics;
querying the second media source for the selected first topic;
combining a search result of the selected first topic from the second media source with a search result of the selected first topic from the first media source;
computing a combined search result for each of the first topics; and
sorting the computed combined search results.

17. The media system of claim 16, wherein the analyzer is further configured to cross-reference the first topics with a second media source by:
combining the first topics having a same subject matter; and
compute a collective result for the combined first topics.

18. A method of transmitting media from aggregating search results for first topics from a first media source with all media sources of a plurality of media sources, the method comprising:
querying the first media source for the first topics;
selecting one of the first topics;
querying a second media source for the selected first topic, the second media source being one of the plurality of media sources;
combining a search result of the selected first topic from the second media source with a search result of the selected first topic from the first media source;
computing a combined search result for each of the first topics;
sorting the computed total search results to determine a most popular topic of an aggregate of the plurality of media sources;
associating the determined most popular topic with User Generated Content, UGC, the UGC being related to the determined most popular topic;
transmitting the combined determined most popular topic and related UGC.

19. The method according to claim 18, further comprising:
determining a subject matter of each of the first topics;
combining the first topics having a same subject matter; and
computing a combined search result for the combined first topics;
applying a semantic filter to the determined most popular topic, the semantic filter configured to determine a category of the determined most popular topic;
transmitting the associated determined most popular topic and related UGC to a moderator module, wherein the UGC is related to the determined category;
determining a discussion vector of the broadcasted media stream; and
adjusting the related UGC based on the determined discussion vector.

20. The method according to claim 19, wherein adjusting the related UGC comprises:
one of promoting a first UGC in a queue and demoting a second UGC in the queue based on the determined discussion vector, the queue being associated with the determined most popular topic.
